(19) United States
(12) Patent Application Publication
(10) Pub. No.: US 2024/0187323 A1
(43) Pub. Date: Jun. 6, 2024

(54) GUARD TIME CALCULATION APPARATUS, GUARD TIME CALCULATION METHOD AND PROGRAM

(71) Applicant: NIPPON TELEGRAPH AND TELEPHONE CORPORATION, Tokyo (JP)

(72) Inventors: Koji SUGISONO, Tokyo (JP); Shinya KAWANO, Tokyo (JP)

(21) Appl. No.: 18/264,987

(22) PCT Filed: Feb. 16, 2021
(86) PCT No.: PCT/JP2021/005730

§ 371 Date: Aug. 10, 2023

(51) Int. Cl. H04L 43/0864; H04L 43/0894

(52) U.S. Cl. CPC H04L 43/0864; H04L 43/0894

(57) ABSTRACT

A guard time calculation device, which is used in a network system including a terminal, a plurality of network functions and an offload device, includes a memory and a processor configured to, in a case where a state transition of a second network function is performed next to a state transition of a first network function, after outputting a packet from the second network function, calculate time it takes that the packet arrives at the offload device via zero or more network functions, and is processed in the offload device, and the packet after processing arrives at the second network function via the zero or more network functions, wherein after the state transition of the first network function is completed and a queued packet is transmitted, the state transition of the second network function is started after a lapse of a guard time on the basis of the time.

### TECHNICAL FIELD

The present invention relates to a technique of changing a flow path on a network.

### BACKGROUND ART

By a development of cloud computing, services requiring high-performance processing such as virtual reality, augmented reality, and online games can be easily delivered to customers. In particular, by off-loading a processing of a mobile terminal which can only mount low calculation processing performance due to restriction of power and sales price to the cloud, these services can be enjoyed while moving.

In such services, since a behavior of user is displayed on a display of the terminal in a natural manner, it is required to shorten offload data between the terminal and the cloud and transfer delay of a result, and to quicken the response to the behavior.

For this reason, attention is focused on mobile edge computing in which an offload device is installed in a cloud arranged near a base station of the mobile service and calculation processing offloaded from the terminal is executed.

In the mobile edge computing, since the number of base stations is very large, resources for calculation in the cloud such as a server and a network line are less than those in the conventional cloud in order to reduce costs for infrastructure investment and maintenance. On the other hand, the number of users accessing the service dynamically changes, and data communication occurs each time, so that a deviation occurs in a communication path, and as a result, the deviation occurs in resources in the cloud. This results in a difference in response between users and shortage of resources for setting a new user path. For this reason, it is required to equalize resources in the cloud by dynamically changing a flow path for improving convenience of service and the number of accommodated users.

In addition, in service operation, network functions (NF), such as a firewall, an intrusion detection system (IDS), etc. are introduced in order to improve convenience.

Such an NF performs processing using a state (which may be referred to as packet processing data) in which latest information of a flow is described. When a part of information is missing, the network function does not operate well. For example, in a case of IDS, it is judged whether the flow is an attack flow to the system or a normal service flow based on the behavior of the flow so far. If some of the states are lost, the flow should be judged to be the attack flow, however is determined to be the normal service flow. Therefore, when dynamically rearranging the flow, the state of the network function which has processed the flow must be simultaneously migrated.

In the flow rearrangement, there is a problem that a transfer delay of a packet flowing through a flow increases. When a flow passes through a network function during a state transition through which the flow passes, the network function cannot be performed on the flow until the state is updated.

Thus, until the state is updated, the network function stores the arrival packets belonging to the flow in the queue. At this time, the queuing delay that each packet suffers changes in accordance with the state transition timing of the network function and the packet traveling direction.

In the service requiring off-loading, when the delay increases in either one of two-way communication between the mobile terminal and the offload device (offload engine), the response of service deteriorates. In view of the above, the conventional method disclosed in the NPL 1 realizes suppression of increase in delay with respect to the flow in both directions.

The conventional method disclosed in the NPL 1 is intended to prevent a packet queued even once from being queued again by other NF. As a method for this purpose, after all the packets queued during the state transition of the NF are transferred, the state transition of the next NF is executed.

### CITATION LIST

### Non Patent Literature

[NPL 1] Koji Sugisono, et al., “Bi-directional Flow Relocation For Computation Offloading With Multiple Network Functions”, in Proc. IEEE international Conference on Cloud Networking (Cloudnet), 2020.

### SUMMARY OF INVENTION

### Technical Problem

The above-mentioned conventional method has the following problems in relation to the off-loading operation by mobile computing.

In interactive communication such as VR/AR or on-line game, an offload device renders an image of a virtual space indicating an operation result on the basis of a user's action and an operation command. The rendering result is sent to the user, so that the user can take the next action.

Thus, the operation result data from the terminal to the offload device is processed by the offload device, and becomes a rendering processing result from the offload device to the terminal. In the conventional method, only a packet of one flow is focused on, and the next state transition is executed when all the packets of the flow are transmitted from the NF that has performed the state transition. Therefore, it is impossible to prevent the rendering result by the packet transferred from the queue from being queued in the next state transition. When the rendering result of the packet transferred from the queue is queued in the next state transition, the delay increases and the user's experience quality deteriorates.

With the foregoing in view, it is an object of the present invention to provide a technique for improving the user's experience quality when rearranging flows flowing through a network function.

### Solution to Problem

According to a disclosed technology, a guard time calculation device, which is used in a network system including a terminal, a plurality of network functions, and an offload device, the guard time calculation device, comprising: in a case where a state transition of a second network function is performed next to a state transition of a first network function, after outputting a packet from the second network function, a calculation means that is provided to calculate time it takes that the packet arrives at the offload device via 0 or more network functions, and is processed in the offload device, and the packet after processing arrives at the second network function via zero or more network functions, wherein

after the state transition of the first network function is completed and a queued packet is transmitted, the state transition of the second network function is started after a lapse of a guard time on the basis of the time.

### Advantageous Effects of Invention

According to the disclosed technology, a technology for improving user's experience quality in a case where a flow flowing through a network function is rearranged is provided.

### BRIEF DESCRIPTION OF DRAWINGS

FIG. 1 is an overall configuration example of a system according to an embodiment of the present invention.

FIG. 2 is a diagram for explaining an example of the state transition.

FIG. 3 is a diagram for explaining an example of the state transition.

FIG. 4 is a diagram for explaining an example of the state transition.

FIG. 5 is a diagram for explaining an example of the state transition.

FIG. 6 is a diagram for explaining an operation example using an offload engine.

FIG. 7 is a diagram for explaining a problem.

FIG. 8 is a diagram for describing an overview of an embodiment.

FIG. 9 is a diagram showing an example of a network configuration in an embodiment of the present invention.

FIG. 10 is a functional configuration diagram of state transition supervisor device.

FIG. 11 is a functional configuration diagram of a packet processing device.

FIG. 12 is a configuration diagram of a base station.

FIG. 13 is a diagram showing an example of a hardware configuration.

FIG. 14 is a diagram showing an operation example of a flow transition.

FIG. 15 is a diagram showing a method for calculating guard time.

FIG. 16 is a diagram showing a method for calculating guard time.

FIG. 17 is a flowchart according to Example 1.

FIG. 18 is a diagram illustrating Example 1.

FIG. 19 is a diagram illustrating Example 1.

FIG. 20 is a flowchart according to Example 2.

FIG. 21 is a diagram illustrating Example 2.

FIG. 22 is a diagram illustrating Example 2.

FIG. 23 is a diagram illustrating an outline of Example 3.

FIG. 24 is a diagram illustrating an outline of Example 3.

FIG. 25 is a flowchart according to Example 3.

FIG. 26 is a diagram illustrating Example 3.

FIG. 27 is a diagram illustrating Example 3

FIG. 28 is a diagram illustrating Example 4.

FIG. 29 is a diagram illustrating Example 4.

FIG. 30 is a diagram illustrating Example 4.

FIG. 31 is a diagram illustrating Example 4.

FIG. 32 is a diagram illustrating Example 4.

FIG. 33 is a diagram illustrating Example 4.

FIG. 34 is a diagram illustrating Example 4.

FIG. 35 is a diagram for illustrating an example of calculation method according to Example 4.

FIG. 36 is a diagram for illustrating an example of calculation method according to Example 4.

FIG. 37 is a diagram for illustrating an example of calculation method according to Example 4.

FIG. 38 is a diagram for illustrating an example of calculation method according to Example 4.

FIG. 39 is a diagram for illustrating an example of calculation method according to Example 4.

FIG. 40 is a diagram for illustrating an example of calculation method according to Example 4.

### DESCRIPTION OF EMBODIMENTS

An embodiment (the present embodiment) of the present invention will now be described with reference to the drawings. The embodiments described below are merely examples, and the embodiments to which the present invention is applied are not limited to the following embodiments. For example, in the following embodiments, a flow to be processed and transferred by a network function is shown in two directions as an example, but the two directions is only example, the flow in three or more directions may be handled.

(Overall Configuration Example of System)

In the present embodiment, a system in which interactive services requiring high-performance processing such as virtual reality, augmented reality, and online games can be easily enjoyed while moving by off-loading the processing of the mobile terminal to the cloud is assumed.

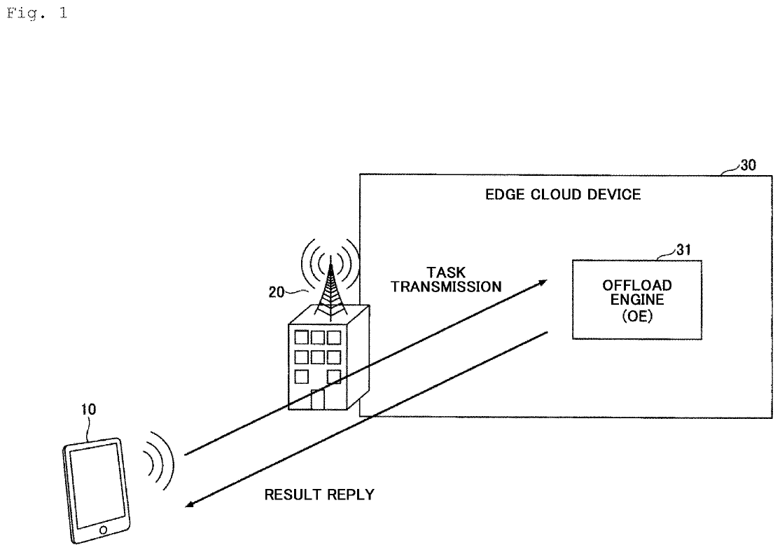

FIG. 1 shows an overall configuration example of a network system according to an embodiment of the present invention. As shown in FIG. 1, the system includes a mobile terminal 10, a base station 20 for mobile service, and an edge cloud device 30.

The edge cloud device 30 is a device that constitutes a cloud for off-loading of a cloud disposed near the base station 20, and executes calculation processing offloaded from the terminal 10. More specifically, for example, an offload engine 31 (which may be referred to as an offload device) that is a VM (virtual machine) in the edge cloud device 30 executes calculation processing of a task requested from the mobile terminal 10. That is, two-way communication of task transmission and result reply is performed. The task input to the offload engine 31 is, for example, operation result data of a user, and the task output from the offload engine 31 in that case is a rendering processing result corresponding to the operation result data. Since the information of the task is transmitted by a packet, the “task” may be called a “packet”.

As described above, in a mobile edge computing, since the number of base stations is very large, in order to reduce costs for infrastructure investment and maintenance, resources for calculation in the cloud such as a server and a network line are less than those in the conventional cloud. On the other band, the number of users accessing the service dynamically changes, and data communication occurs each time, so that a deviation occurs in a communication path, and as a result, the deviation occurs in resources in the cloud. This results in a difference in response between users and shortage of resources for setting a new user path. For this reason, it is required to equalize resources in the cloud by dynamically changing a flow path for improving convenience of service and the number of accommodated users.

In addition, during service operation, network functions (NF) such as a firewall, an intrusion detection system (IDS), etc. are introduced for convenience improvement. As described above, such NF performs processing using a state in which the latest information of the flow is described. When a part of information is missing, the network function does not operate well. For example, in a case of IDS, it is judged whether the flow is an attack flow to the system or a normal service flow based on the behavior of the flow so far. If some of the states are lost, the flow should be judged to be the attack flow, however is determined to be the normal service flow. Therefore, when dynamically rearranging the flow, the state of the network function which has processed the flow must be simultaneously migrated.

In the present embodiment, a network function requiring the above-mentioned state for its operation is assumed as the network function. Such the network function is called a state-full network function.

When the flow passes through the network function during the state transition, since the network function cannot perform processing to the flow until the state is updated, the network function stores the arrival packet belonging to the flow in a queue until the state is updated. Therefore, the transfer delay of the packet flowing in the flow increases in the flow rearrangement.

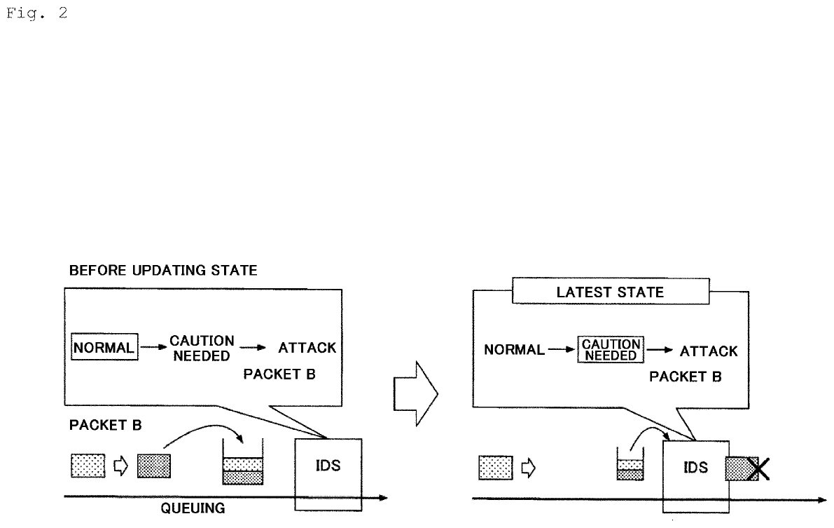

An example will be described with reference to FIG. 2. FIG. 2 shows the transition of the state in the rearrangement of the flow in the case where the IDS is used as the network function. As shown in the left side of FIG. 2, before the state is updated, since there is no state in which the sign of the attack is recorded, the packet is queued without restarting the processing. Thereafter, when the transition of the state is completed, the processing is resumed as illustrated on the right side of FIG. 2, and for example, it is possible to detect that the packet B is an attack packet.

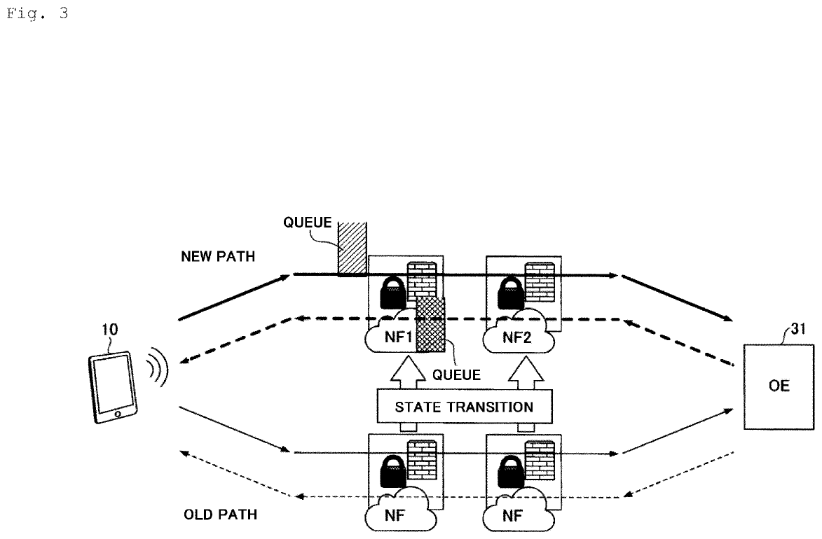

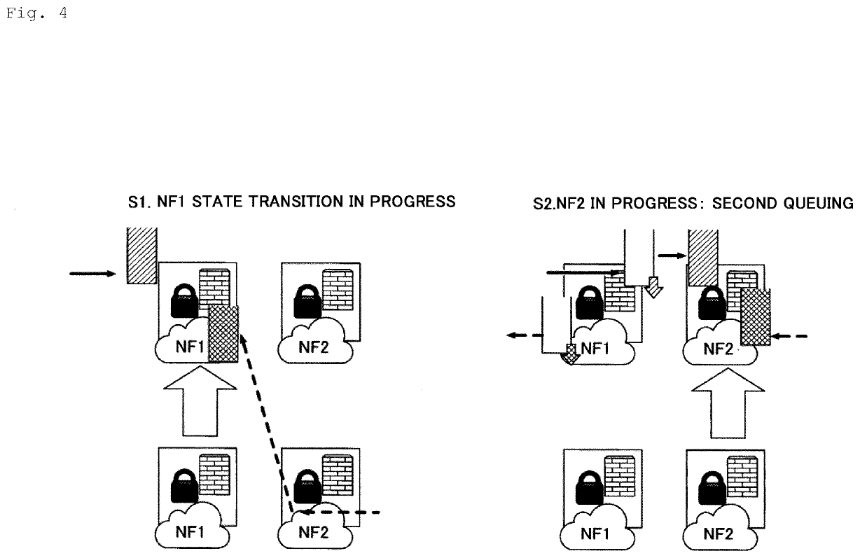

As described above, the network function stores the arriving packets belonging to the flow in the queue until the state is updated, and at this time, the queuing delay that each packet suffers changes in accordance with the state transition timing of the network function and the packet traveling direction. This will be described by using an example with reference to FIGS. 3 and 4.

As illustrated in FIG. 3, there are two network functions between the mobile terminal 10 and the offload engine 31, and NF1 and NF2 are respectively used. Both of the NF1 and NF2 are state management type network functions for managing the state of the flow and changing the processing method according to the contents of the state. As shown in FIG. 3, it is assumed that the flow is rearranged to change the passage path of the flow to another place. In the NF1 and the NF2, a situation is considered in which start timing of state transition is sequential and continuous. Immediately after the state transition of the NF1 is completed, the state transition of the NF2 is performed. In FIG. 3 or the like, when the picture of the queue is shaded, it indicates that a packet is accumulated.

Next, the description will be given with reference to FIG. 4. As shown in S1 in FIG. 4, during the state transition of the NF1, respective packets from the NF1 to the NF2 and from the NF2 to the NF1 are queued at the NF1. As shown in S2, after the state transition of the NF1 is completed, the former packet is directed to the NF2 and the latter packet is directed to the mobile terminal 10. Since the NF2 starts the state transition immediately after the completion of the state transition of the NF1, the former packet is queued again immediately after arriving at the NF2.

As shown in FIG. 4, in the transition of states of NF1 and NF2, the number of standby times for the flow from NF2 to NF1 is one, whereas the number of standby times for the flow from NF1 to NF2 is two.

In this way, when the start timing of the state transition in the plurality of NFs is made to be sequential and continuous, the number of standby times that the packet suffers, that is, the waiting time, varies depending on the direction.

This transition method is used when the state transition of all NFs is completed earlier and each NF packet processing resource used before the transition is desired to be released earlier. Further, the number of times that packets of the flow from the NF2 to the NF1 are queued is suppressed to one at the maximum by continuously transition. There is a transition method in which states of the NF1 and the NF2 are simultaneously performed in parallel, but in this system, queuing time is prolonged in both directional flows.

In the service requiring off-loading, when the delay increases in either one of two-way communication between the mobile terminal 10 and the offload engine 31, the response of service deteriorates.

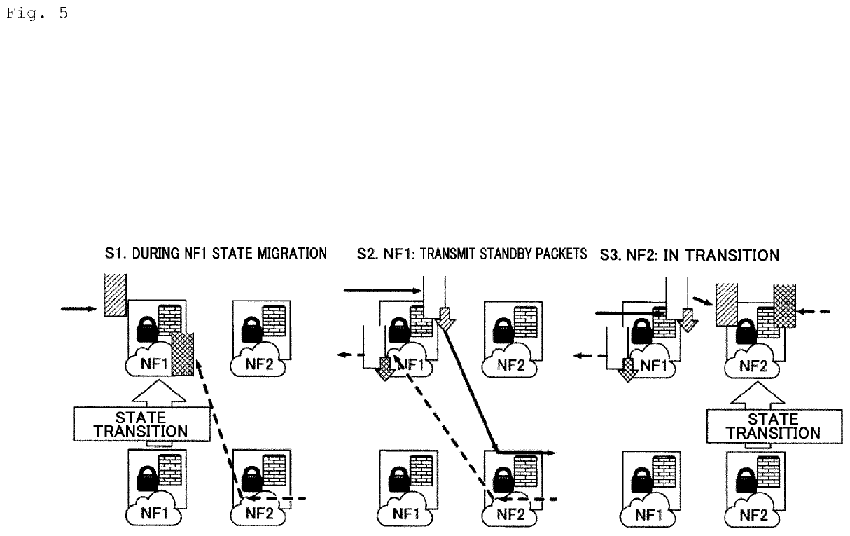

The technique disclosed in the NPL 1 solves the above problem, and enables suppression of an increase in a transfer delay during flow rearrangement for a packet directed in either direction. The technique will be described with reference to FIG. 5.

In FIG. 5, as in the case of FIGS. 3 and 4, there are two network functions between the mobile terminal 10 and the offload engine 31, respectively, NF1 and NF2, it is assumed that the state transition of the NF2 is performed immediately after the state transition of the NF1 is completed.

In this technology, after the completion of the NF state transition, the next NF state transition is executed after the waiting packets have been forwarded, so that the maximum number of standby times for a packet is one, and packets that have waited once are not waited for during the next state transition.

That is, in S1 of FIG. 5, during the state transition in the NF1 after the state transition is started, the packets from the NF1 to the NF2 are queued in the NF1 of the state transition destination, and the packets from the NF2 to the NF1 are queued at the same time.

When the transition of the state in the NF1 is completed in S2, the packets waiting by queuing are transmitted from the NF1. When two queues in the NF1 becomes empty, the state transition of the NF2 is executed in S3.

(Issues)

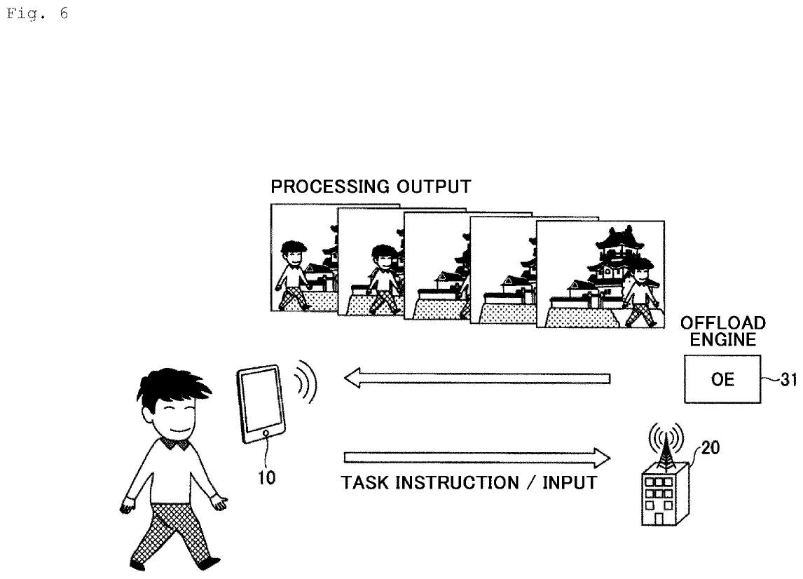

FIG. 6 shows an off-loading operation by mobile computing. As described above, in the interactive communication such as VR/AR or on-line game, a task execution instruction is transmitted from the terminal 10 to the offload engine 31 on the basis of the user's action and operation commands, and the offload engine 31 renders the image of the virtual space indicating the operation result. The rendering result (task execution result) is sent to the terminal 10, and then the user takes the next action. In this way, the flow is bidirectional. The offload deteriorates the response when the round trip time (RTT) used in interactive (online game, VR, etc.) services is long.

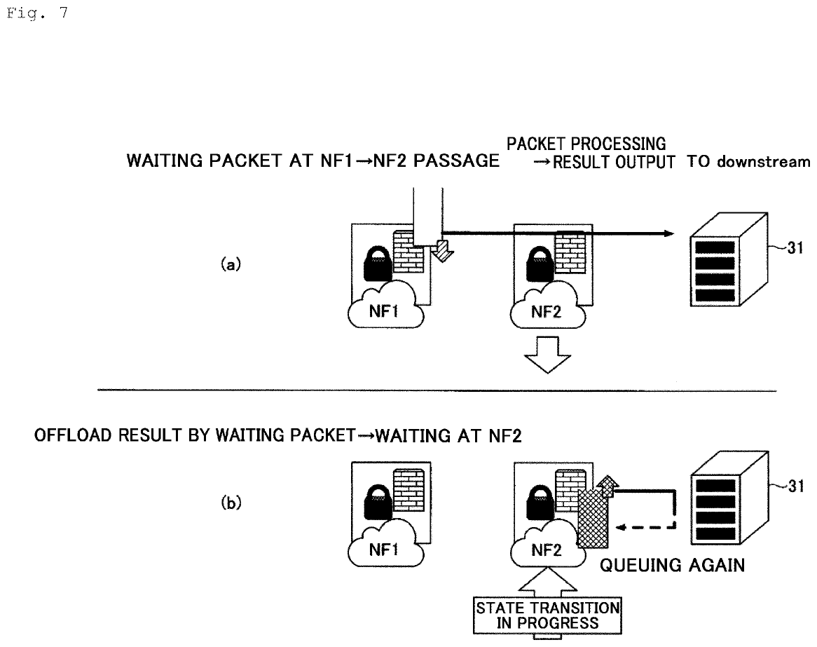

The problem in the case of using the conventional method in the flow rearrangement will be described with reference to FIG. 7. As described above, in the conventional method, only one flow of packets is noticed, and the next state transition is executed when all the Packets of the flow are transmitted from the NF which has performed the state transition.

In the example of FIG. 7, since the state transition at the NF1 is completed in (a), the NF1 transmits the queued packet. In this example, the upstream traffic (the direction from the terminal 10 to the offload engine 31) is shown.

The offload engine 31 outputs a processing result after receiving the upstream traffic. This traffic is the downstream traffic. Since the state transition of the NF2 is started after the completion of the state transition of the NF1, the downstream traffic is queued again in the NF2 as shown in (b).

That is, the case occurs in which the downstream stream traffic generated by the upstream stream traffic waiting in the NF1 waits the NF2. Thus, the transfer delay is extended and the service response is deteriorated. When the response is deteriorated, the quality of the user's experience quality is deteriorated.

### Overview of Embodiment

in order to solve the above problem, in the present embodiment, the start timing of the next state transition is determined so that the task output (rendering result) is not queued again by the NF, thereby improving the user's experience quality of the user.

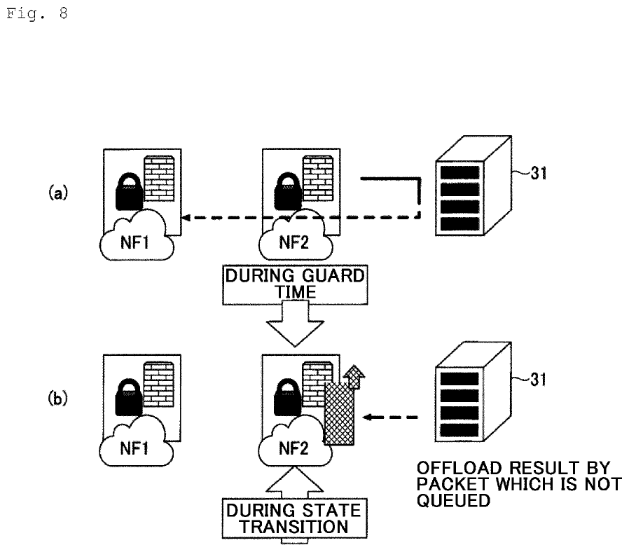

The outline of this embodiment will be described with reference to FIG. 8. FIG. 8 shows a situation from completion of the state transition of the NF1 to a time point when the state transition of the NF2 is started. In the present embodiment, the state transition of a certain NF is completed, and after the processing (output) of a packet (task input) waiting for the NF, the state transition of the next NF is executed after the guard time.

As shown in FIG. 8(a), during the guard time after the state transition is completed, the NF1 processes (outputs) a packet (task input) waiting at the NF1, the offload engine 31 processes, and the downstream traffic is returned. During the guard time, the NF2 is not queued since it is before the start of the state transition.

As shown in FIG. 8(b), after the guard time has elapsed, the state transition of the NF2 is started. At this time, the packet queued in the NF2 at this time is a result of the offload processing on the packet that has not been queued at once.

The guard time of Examples 1 to 3 described later corresponds to the time until all the task output for the task input queued in the NF1 passes through the NF2. In the Example 4 described later, the guard time is determined by using a QoE (Quality of Experience) determination function for outputting the quality of user's experience quality. In any of the Examples, the user's experience quality is improved by the guard time.

The guard time is calculated in consideration of the packet processing time in the NF and the offload engine and the inter-NF transfer delay. In the following description of the Examples, an example of a guard time calculation method will be described in detail.

(Detailed Configuration Example of the System)

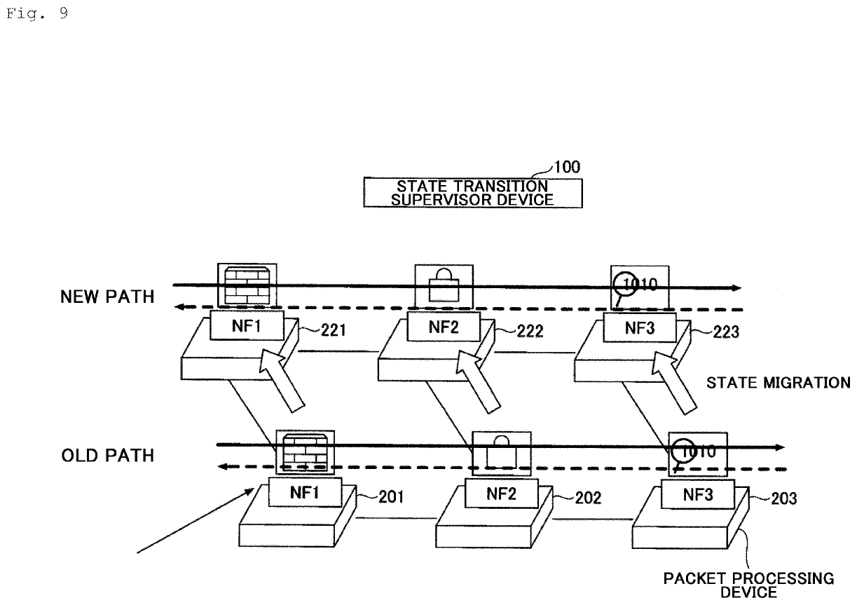

FIG. 9 shows an example of the detailed configuration of the system according to the present embodiment. As shown in FIG. 9, this system has a state transition supervisor device 100 and a plurality of packet processing devices 201 to 203 and 221 to 223. Each packet processing device can communicate with each other through a transmission line. The state transition supervisor device 100 and each packet processing device can communicate with each other through, for example, a control line. As shown in FIG. 1, a base station 20 is also present in the system of the present embodiment, and the base station 20 can communicate with each NF (each packet processing device).

It is assumed that a bidirectional flow between the mobile terminal 10 and the offload engine 31 is rearranged from an old path (packet processing devices 201 to 203) to a new path (packet processing devices 221 to 223), and at that time, state transition is performed as shown in the figure.

The packet processing devices 201 and 221 include the NF1 as the network function, the packet processing devices 202 and 222 include the NF2 as the network function, and the packet processing devices 203 and 223 include the NF3 as the network function. The NF1, NF2, and NF3 are firewall, IDS, or the like, and any of them may operate as a virtual machine on the packet processing device or may be implemented in hardware in the packet processing device. Note that the network function may be referred to as the packet processing device. That is, the network function and the packet processing device may be synonymous.

When the flow is rearranged, the state of the NF1 is transferred from the packet processing device 201 to the packet processing device 221, the state of the NF2 is transferred from the packet processing device 202 to the packet processing device 222, and the state of the NF3 is transferred from the packet processing device 203 to the packet processing device 223.

The state transition supervisor device 100 supervises and manages the state transition as described above. Further, the state transition supervisor device 100 calculates a guard time. The base station 20 can also calculate the guard time.

(Device Configuration)

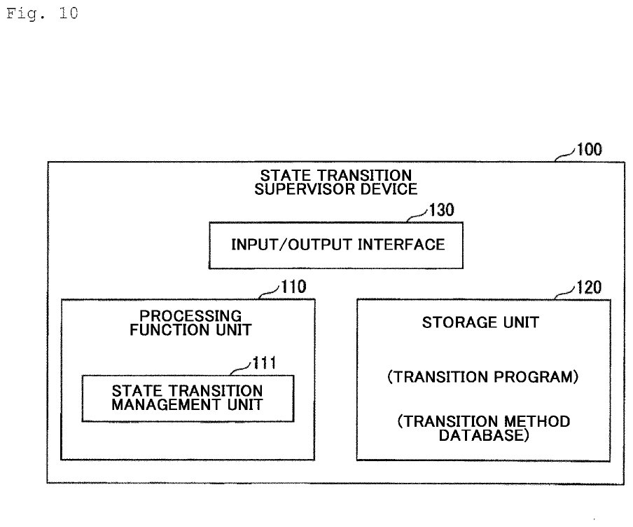

FIG. 10 shows a function configuration diagram of the state transition supervisor device 100 according to the present embodiment. As shown in FIG. 10, the state transition supervisor device 100 includes a processing function unit 110, a storage unit 120, and an input/output interface 130. The processing function unit 110 includes a state transition management unit 111. The state transition management unit 111 may be called calculation means. The storage unit 120 stores a transition program, a guard time calculation program, a transition method database, data used for guard time calculation, and the like. For example, the guard time calculation program is executed by the state transition supervisor device 100, which is a computer, to realize the state transition management unit 111, and the state transition management unit 111 may perform the calculation processing.

The state transition management unit 111 receives a state transition completion notification from the NF via the input/output interface 130. The state transition management unit 111 receives information necessary for guard time calculation via an input/output interface (or acquires the information from the storage unit 120), calculates the guard time, on the basis of the guard time, a state transition start is instructed to an NF for performing a state transition next to the NE for which the state transition is completed. In addition, when executing the operation of Example 4, the state transition management unit 111 includes a functional unit that determines the QoE of the service from the maximum value of the delay increases amount and the threshold delay amount excess time, and a functional unit that determines the optimal QoE using the functional unit and calculates the guard time corresponding to the set of the maximum value of the delay increases amount and the threshold delay amount excess time corresponding to the optimal QoE.

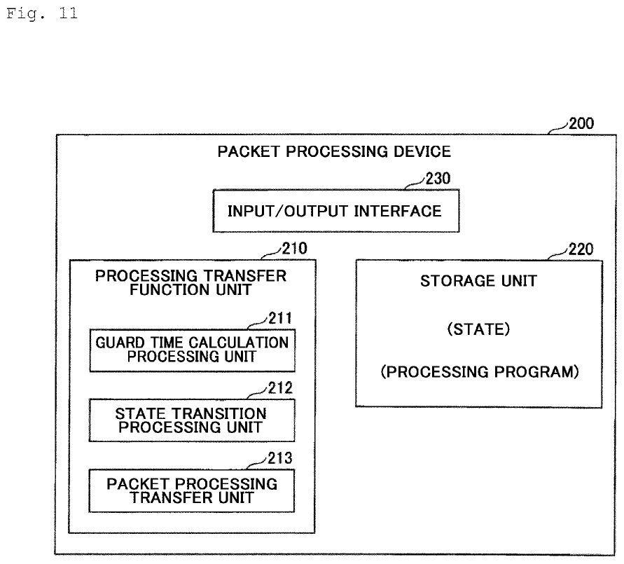

FIG. 11 shows a function configuration diagram of a packet processing device 200 according to the present embodiment. The packet processing device 200 can be used as any packet processing device of the packet processing devices 201 to 203 and 221 to 223 illustrated in FIG. 9.

As shown in FIG. 11, the packet processing device 200 includes a processing transfer function unit 210, a storage unit 220, and an input/output interface 230. The processing transfer function unit 210 includes a guard time calculation processing unit 211, a state transition processing unit 212, and a packet processing transfer unit 213. Note that the processing transfer function unit 210 may be referred to as “the network function”. Further, the packet processing device itself may be referred to as “network function”.

The input/output interface 230 may be referred to as a transmission unit or a reception unit. The storage unit 220 stores a state, a processing program, and the like. For example, the processing transfer function unit 210 may be realized by executing the processing program by the packet processing device 200 which is a computer.

The storage unit 220 may include a queue function. That is, the storage unit 220 may store packets to be queued. The packet processing transfer unit 213 may include a queue function.

The guard time calculation processing unit 211 executes the processing for the guard time calculation of the Example 2. The guard time calculation processing unit 211 may be called calculation means. When executing the operation of the Example 4, the guard time calculation processing unit 211 includes a function unit for determining the QoE of the service from the maximum value of the delay increases amount and the threshold delay amount excess time, and a function unit for determining an optimal QoE using the functional unit and calculating a guard time corresponding to a set of the maximum value of the delay increases amount corresponding to the optimal QoE and the threshold delay amount excess time.

The state transition processing unit 212 includes a function of transmitting the state to the transition destination of the state, a function of receiving the state from the transition source of the state, and the like. The state transition processing unit 212 may be referred to as a packet processing data reception unit or a packet processing data transmission unit.

In addition, the state transition processing unit 212 has a function of notifying the state transition supervisor device 100 that the processing of the packet of the specific flow is completed among the packets of the plurality of flows stored in the storage unit 220, and a function of starting the transmission of the state on the basis of the instruction from the state transition supervisor device 100.

The packet processing transfer unit 213 includes a function of storing the arrived packet in the queue, reading the packet stored in the queue when the transition of the state is completed, processing the packet, and transferring the packet to the destination. The processing of the packet is, for example, processing of the packet in the firewall described above, processing of the packet in the IDS, or the like.

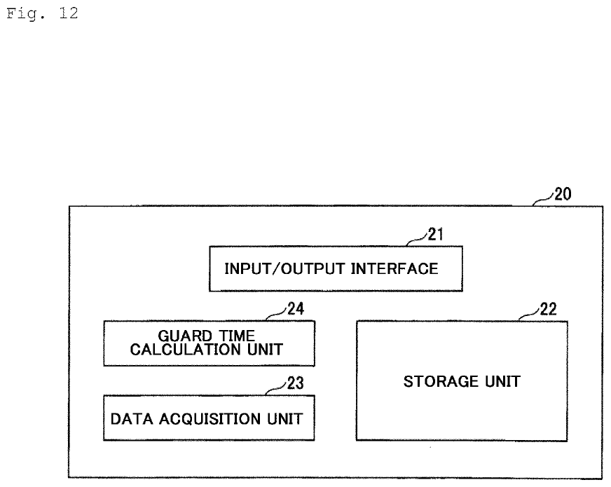

FIG. 12 is a functional configuration diagram of the base station 20. The configuration of the base station 20 is assumed to be the Examples 3 and 4. In the Examples 1 and 2, the base station 20 may be a general base station. As illustrated in FIG. 12, the base station 20 includes an input/output interface 21, a storage unit 22, a data acquisition unit 23, and a guard time calculation unit 24. The guard time calculation unit 24 may be called a calculating means.

The input/output interface 21 communicates with other devices such as a terminal 10, an NF (packet processing device), a state transition supervisor device 100, and the like. The data acquisition unit 23 measures an RTT (and R to be described later) between the data acquisition unit 23 and another device via the input/output interface 21, and stores the measured RTT in the storage unit 22. A guard time calculation unit 24 reads the data from the storage unit 22, calculates a guard time, and notifies the NF of the guard time in a certain NF to a corresponding NF. Further, the guard time calculation unit 24 may notify the state transition supervisor device 100 of the guard time in the NF.

In addition, when the operation of Example 4 is executed, the guard time calculation unit 24 includes a functional unit that determines the QoE of the service from the maximum value of the delay increases amount and the threshold delay amount excess time, and a functional unit that determines the optimal QoE using the functional unit and calculates the guard time corresponding to the set of the maximum value of the delay increases amount and the threshold delay amount excess time corresponding to the optimal QoE.

More specific operations of the state transition supervisor device 100, the packet processing device 200, the base station 20, and the like will be described later. The state transition supervisor device 100, the packet processing device 200, and the base station 20 may be referred to as a guard time calculation device.

(Hardware Configuration Example)

The state transition supervisor device 100, the packet transfer device 200, the base station 20, the terminal 10, and the offload engine 31 (these are collectively referred to as “device”) according to the present embodiment can be realized by causing a computer to execute a program describing the processing contents described in the present embodiment, for example. Note that the “computer” may be a physical machine or a virtual machine in the cloud. When using a virtual machine, the “hardware” described here is virtual hardware.

The program can be recorded on a computer-readable recording medium (portable memory, and the like), stored, and distributed. It is also possible to provide the program through a network such as the Internet or an email.

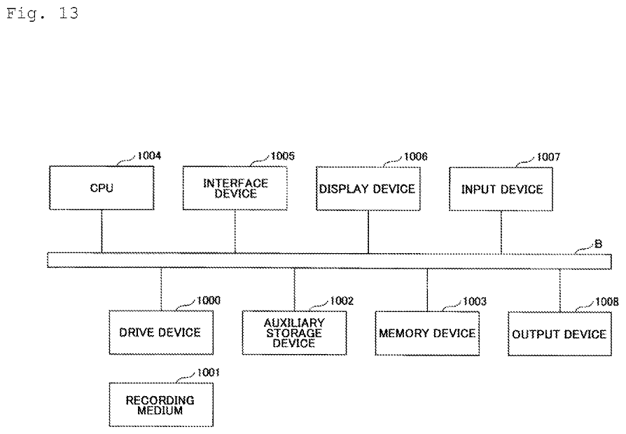

FIG. 13 is a diagram illustrating an example of a hardware configuration of the computer. The computer of FIG. 13 includes a drive device 1000, an auxiliary storage device 1002, a memory device 1003, a CPU 1004, an interface device 1005, a display device 1006, an input device 1007, an output device 1008, and the like, which are mutually connected via a bus B.

A program for realizing the processing of the computer is provided by a recording medium 1001 such as a CD-ROM or a memory card, for example. When the recording medium 1001 storing the program is set in the drive device 1000, the program is installed onto the auxiliary storage device 1002 from the recording medium 1001 via the drive device 1000. However, the program may not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the device according to the program stored in the memory device 1003. The interface device 1005 is used as an interface for connection to a network. The display device 1006 displays a graphical user interface (GUI) or the like according to a program. The input device 1007 is configured of a keyboard, a mouse, buttons, a touch panel, and the like, and is used for inputting various operation instructions. The output device 1008 outputs a calculation result. Note that the display device 1006, the input device 1007, and the output device 1008 may not be provided in the packet processing device 200.

(Operation Example of the Flow Rearrangement)

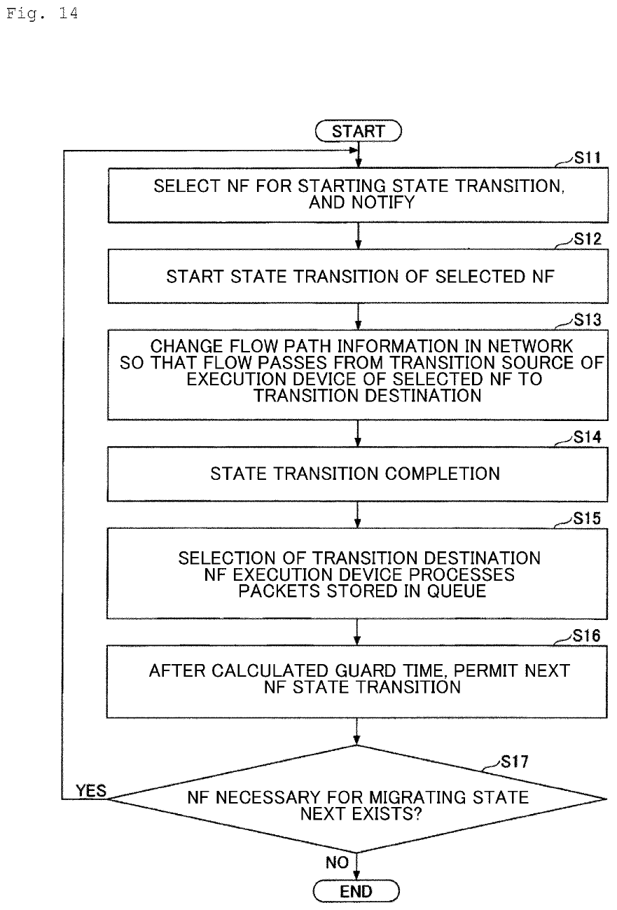

An overall operation example during execution of flow rearrangement will be described in the present embodiment with reference to the flowchart of FIG. 14.

In S11, the state transition supervisor device 100 selects an NF for starting state transition, and notifies the NF of the start of state transition. In S12, the state transition of the selected NF is started.

In S13, the state transition supervisor device 100 changes the flow path information in the network so that the flow passes from the transition source to the transition destination of the execution device (packet processing device) of the selected NF.

When the state transition is completed in S14, the execution device of the selection NF of the transition destination processes the packet stored in the queue in S15. In S16, the state transition of the next NF is permitted after the lapse of the calculated guard time.

In S17, when an NF requiring to shift the state next exists, the process returns to S11, and when the NF requiring to shift the state next does not exist, the process ends.

(Configuration of Guard Time)

The guard time in this embodiment is composed of packet processing time in the NF and offload engine 31 and packet transfer time between adjacent NF (and between NF and offload engine).

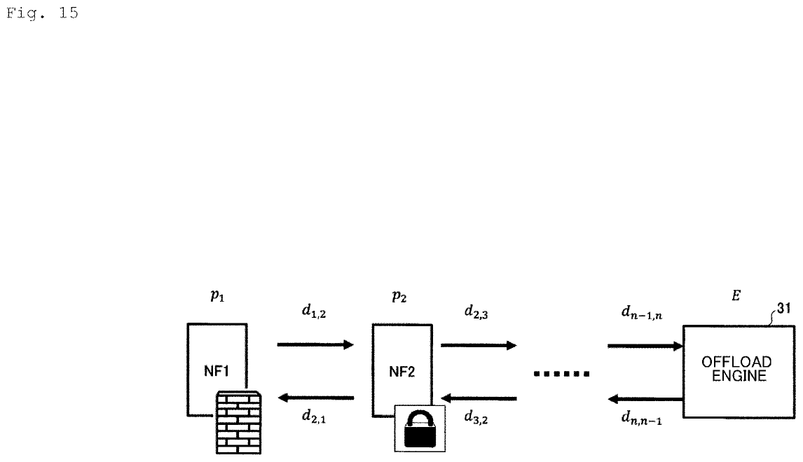

Specifically, as shown in FIG. 15, when the processing time in the offload engine 31 is E, the transfer delay when the packet goes from the NFⱼ to the NFⱼ₊₁ is d_{j,j+1}, when the packet processing delay at NFⱼ is assumed to be pⱼ, the guard time G is expressed by the following equation. Here, “Σⁿ⁻¹ⱼ₌ᵢ₊₂pⱼ” indicates the sum of j=i+2 to j=n−1 of pⱼ.

G≥E+Σⁿ⁻¹ⱼ₌ᵢ₊₁(d_{j,j+1}+d_{j+1,j})+Σⁿ⁻¹ⱼ₌ᵢ₊₂pⱼ

Since an inequality sign is used in the above expression, G may be a value equal to or greater than “E+Σⁿ⁻¹ⱼ₌ᵢ₊₁(d_{j,j+1}+d_{j+1,j})+Σⁿ⁻¹ⱼ₌ᵢ₊₂pⱼ”, but in the following description, it is assumed that “G=E+Σⁿ⁻¹ⱼ₌ᵢ₊₁(d_{j,j+1}+d_{j+1,j})+Σⁿ⁻¹ⱼ₌ᵢ₊₂pⱼ”.

(Guard Time Derivation Method)

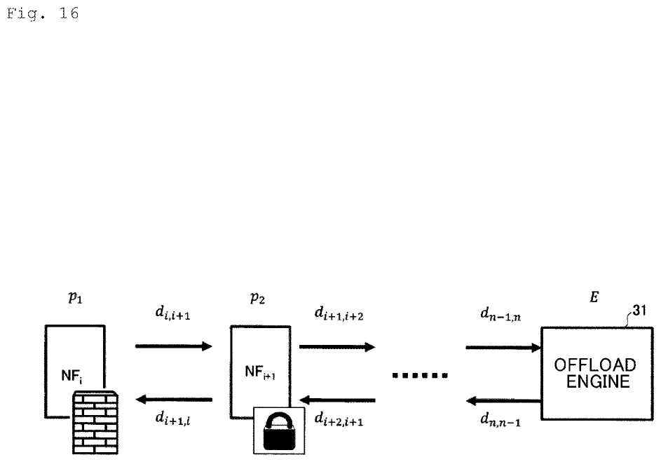

Next, a method of deriving the above equation will be described. FIG. 16 shows NF, d, p and E used in the following description.

Here, it is assumed that the states are shifted in the order of NF1→NF2→ . . . →NFn−1, and a guard time until the state shift of NFᵢ₊₁ is started after the state transition of NFᵢ is completed is calculated. Specifically, the time until the return of the last packet arriving at the NF passes through the NFᵢ₊₁ at the time of transition of the state of the NFᵢ is calculated. More specifically, the following is performed.

<A. Time Until Last Packet is Turned Back to Pass Through NFᵢ₊₁>

When the state transition completion time of the NFᵢ is set to 0, the passing time of the target packet (the last packet) of the NFᵢ₊₁ is as follows. The NFₙ₋₁ is an NF adjacent to the offload engine.

The passing time of the packet of interest of the NFᵢ₊₁=processing time of all packets waiting during the transition to the NFᵢ state+“transfer time of NFᵢ→NFᵢ₊₁”+“processing time of NFᵢ₊₁”+“transfer time of NFᵢ₊₁→NFᵢ₊₂”+“processing time of NFᵢ₊₂”+ . . . +processing time in an offload engine+“transfer time of offload engine→NFₙ₋₁”+“processing time of NFₙ₋₁”+ . . . +“transfer time of NFᵢ₊₂→NFᵢ₊₁”

<B. State Transition Start Time of NFᵢ₊₁ in the Absence of a Guard Time>

The state transition start time of NFᵢ₊₁ in the absence of a guard time is as follows.

A state transition start time of NFᵢ₊₁ when there is no guard time=processing time of all packets waited during the transition to the NFᵢ state+“transfer time of NFᵢ→NFᵢ₊₁”+“processing time in NFᵢ₊₁”

<C. Guard Time>

The guard time is obtained by subtracting the state transition start time of NFᵢ₊₁ in a case where there is no guard time from the time when the last packet is turned back to pass through NFᵢ₊₁. That is, the guard time is calculated as follows.

Guard time=“transfer time of NFᵢ₊₁→NFᵢ₊₂”+“processing time in NFᵢ₊₂”+ . . . +processing time in an offload engine+“transfer time of offload engine→NFₙ₋₁”+“processing time of NFₙ₋₁”+ . . . +“transfer time of NFᵢ₊₂→NFᵢ₊₁”=E+Σⁿ⁻¹ⱼ₌ᵢ₊₁(d_{j,j+1}+d_{j+1,j})+Σⁿ⁻¹ⱼ₌ᵢ₊₂pⱼ

(On Guard Time Data Collection and Calculation Method)

In this embodiment, three examples of guard time data collection and guard time calculation methods will be described as Examples 1 to 3. An example of a guard time calculation method using the optimization of QoE will be described as an Example 4. The summary of Examples 1 to 3 is as follows.

Example 1: Each packet processing unit 200 (each NF) performs data measurement and notifies the state transition supervisor device 100 of the measurement result. The state transition supervisor device 100 calculates a guard time by using the measurement result received from each packet processing device 200 (each NF), and uses the calculated guard time for state transition.

Example 2: The NF (NFᵢ₊₁) to be next state transition target executes measurement using a measurement packet (a packet in which a transmission time or the like is recorded), and calculates a guard time using the measurement value. When receiving a transition instruction from the previous state transition NF (NFᵢ), the next state transition target NF (NFᵢ₊₁) starts transition after the guard time.

Example 3: The base station 20 measures RTT to the terminal 10, each NF, and the offload engine 31, and the terminal 10 measures RTT of task input and output. The base station 20 calculates a guard time on the basis of these measured values. Hereinafter, each Example will be described in detail.

### Example 1

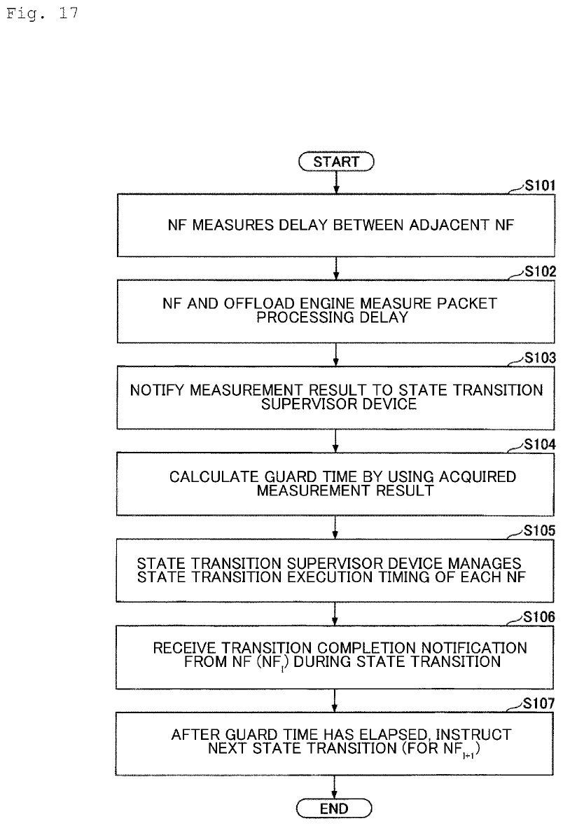

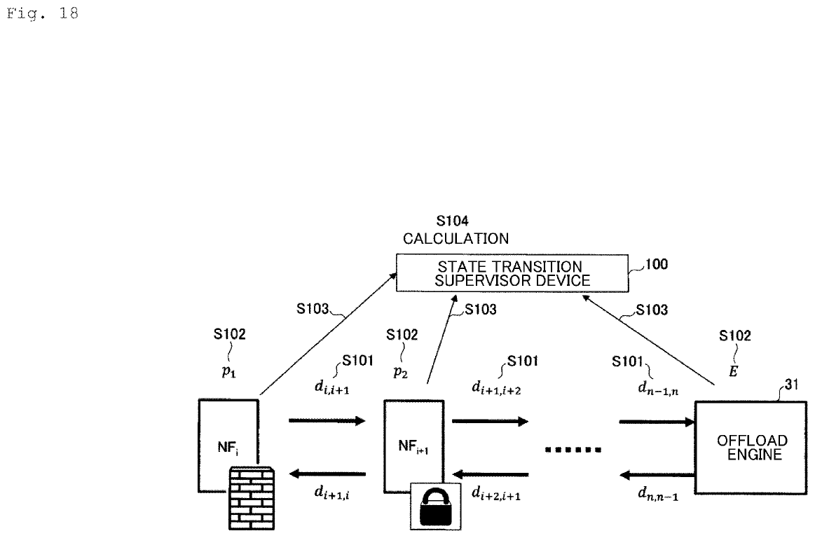

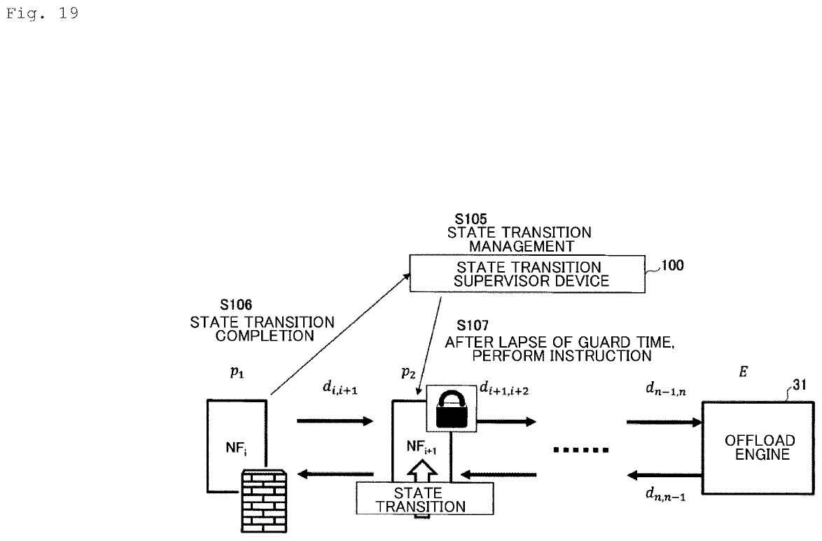

First, Example 1 will be described. Example 1 is an example of a method of performing data measurement in each NF. FIG. 17 is a flowchart of Example 1. FIGS. 18 and 19 show information exchange in the system. The step numbers shown in FIGS. 18 and 19 correspond to the step numbers in the flowchart of FIG. 17. The operation of Example 1 will be described with reference to FIGS. 17, 18, and 19.

S101 to S104 in FIG. 17 correspond to FIG. 18. In S101, each NF measures a delay between the NF and an adjacent NF (or the offload engine 31). For example, the NFᵢ measures d_{i,i+1} and d_{i+1,i}.

In S102, each NF and the offload engine 31 measure packet processing delay (p, E). In step S103, each NF and the offload engine 31 notify the state transition supervisor device 100 of the measurement results measured in steps S101 and S102.

In step S104, the state transition supervisor device 100 calculates the guard time using the measurement result acquired in step S103 and the above-described equation.

S105 to S107 in FIG. 17 correspond to FIG. 19. In S105, the state transition supervisor device 100 manages the state transition execution timing of each NF. For example, the NF that is currently in the state transition and the NF that performs the next state transition are grasped.

In S106, the state transition supervisor device 100 receives a transition completion notification from an NF (NFᵢ) during state transition. In S107, the state transition supervisor device 100 instructs the next state transition to the NFᵢ₊₁ after the guard time elapses from the time point of receiving the transition completion notification. The point of time when the transfer completion notification is received corresponds to the time when the last packet queued in the NFᵢ is output.

### Example 2

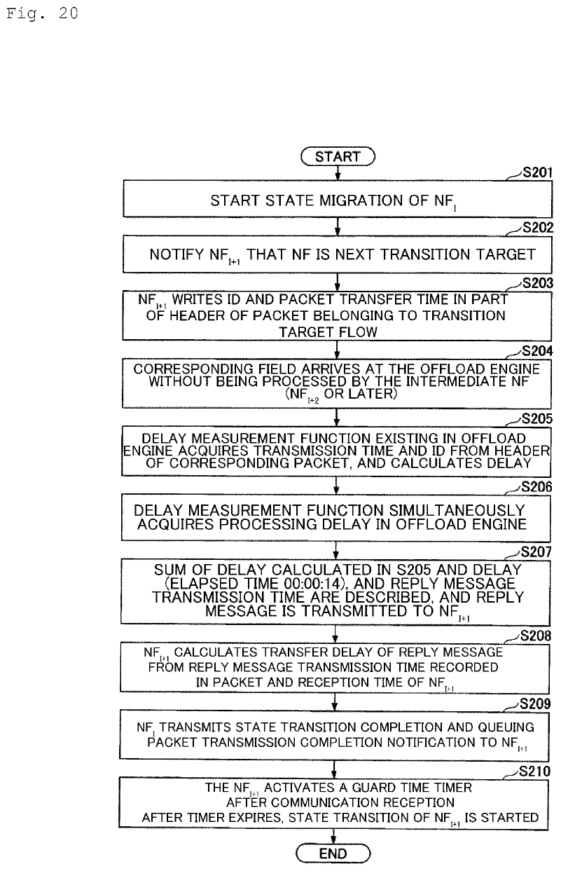

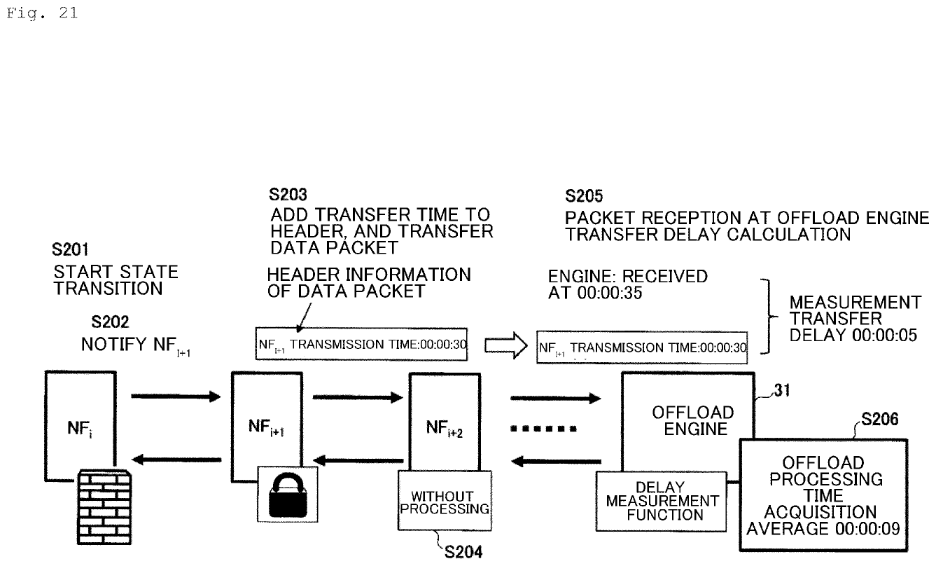

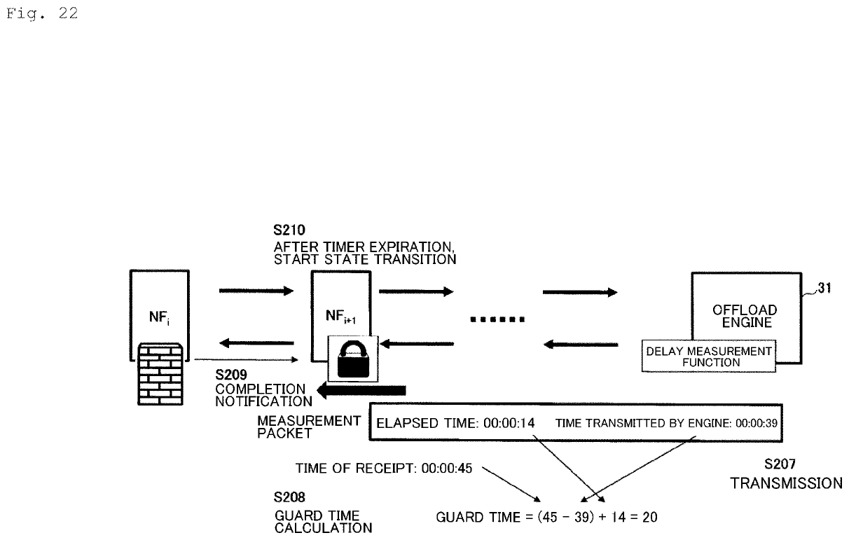

Next, Example 2 will be described. Example 2 is an example of a method of embedding measurement data in a data packet. FIG. 20 is a flowchart of Example 2. FIGS. 21 and 22 show information exchange in the system. The step numbers shown in FIGS. 21 and 22 correspond to the step numbers of the flowchart in FIG. 20. The operation of Example 2 will be described with reference to FIGS. 20, 21, and 22.

S201 to S206 in FIG. 20 correspond to FIG. 21. In S201, the state transition of the NFᵢ is started.

In S202, the NF; notifies the NFᵢ₊₁ that the NFᵢ₊₁ is the next transition target.

In S203, the NFᵢ₊₁ writes its own ID and the transmission time of the packet in a part of the header of the packet belonging to the transition target flow, and transfers the packet. The packet in which the information is added to the header is directed to the offload engine 31. As shown in S204, the field of the header information arrives at the offload engine 31 without being processed by the intermediate NF (NFᵢ₊₂ and subsequent).

In S205, the offload engine 31 receives the packet transmitted from the NFᵢ₊₁, and the delay measurement function existing in the offload engine 31 acquires the transmission time and the ID from the header of the packet, calculates a difference between the transmission time and the reception time, and sets the calculation result as the delay from the NFᵢ₊₁ to the offload engine 31. In the example of FIG. 21, the delay is calculated as 00:00:05.

In S206, the delay measurement function simultaneously acquires the processing delay in the offload engine 31 from the process of the engine or the kernel. In the example of FIG. 21, this value is 00:00:09.

S207 to S210 in FIG. 20 correspond to FIG. 22. In S207, the offload engine 31 describes the sum of the calculated transfer delay and the processing delay (elapsed time 00:00:14 illustrated in FIG. 22 and the reply message transmission time in the reply message, and transmits the reply message to NFᵢ₊₁.

In S208, the NFᵢ₊₁ receives the reply message, and calculates a transfer delay of the reply message from the reply message transmission time recorded in the received reply message and the reception time of the NFᵢ₊₁. In the example of FIG. 22, the calculation is performed as 45−39=6. The NFᵢ₊₁ sets the sum of the “transfer delay from the NFᵢ₊₁ to the offload engine 31+offload processing delay” (14 in FIG. 22) recorded in the reply message and the transfer delay of the reply message as the guard time. In the example of FIG. 22, the calculation is performed as 20.

In 8209, the NFᵢ notifies the NFᵢ₊₁ of the state transition completion and transmits a queuing packet transmission completion notification. In S210, after receiving the queuing packet transmission completion notification, the NFᵢ₊₁ activates a guard time timer, and after expiration of the timer, starts transition of the state of the NFᵢ₊₁.

### Example 3

Next, Example 3 will be described. First, a method of calculating the guard time in Example 3 will be described. In Example 3, the guard time is calculated using the measured value of the RTT.

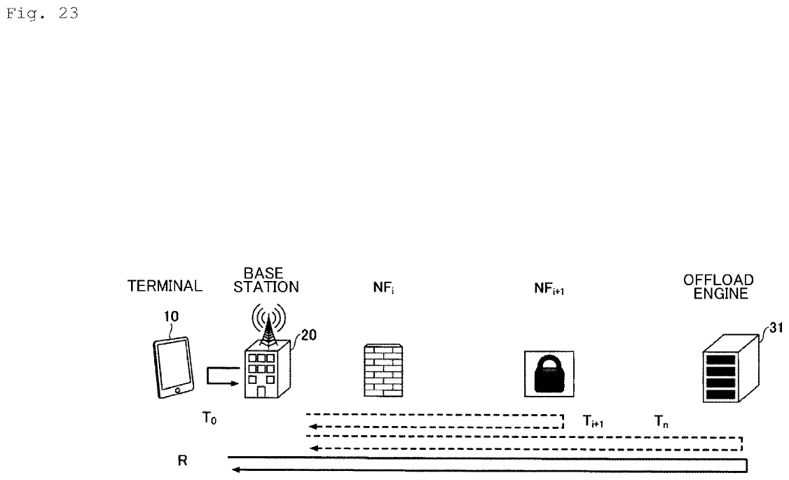

As illustrated in FIG. 23, the base station 20 measures RTT (T₀) between the base station 20 and the terminal 10, RTT (Tᵢ₊₁, or the like) between the base station 20 and each NF, and RTT (Tₙ) between the base station 20 and the offload engine 31. The terminal 10 also measures a time (R) from task input transmission to output reception. Note that measuring the RTT between the base station 20 and a certain device from the base station 20 as a starting point may be expressed as measuring the RTT to the device by the base station 20.

Next, the correspondence between the above-described measurement value and the above-described calculation formula of the guard time will be described.

As described above, the guard time can be calculated by the following equation.

G≥E+Σⁿ⁻¹ⱼ₌ᵢ₊₂pⱼ+Σⁿ⁻¹ⱼ₌ᵢ₊₁(d_{j,j+1}+d_{j+1,j})

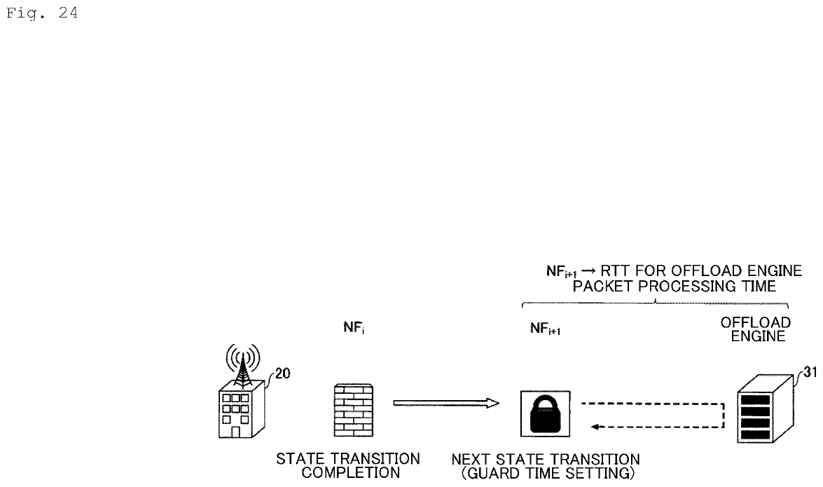

In the above equation, “E+Σⁿ⁻¹ⱼ₌ᵢ₊₂pⱼ” corresponds to each NF of the packet transferred between the NFᵢ₊₁ and the offload engine 31 and the packet processing time in the offload engine 31 shown in FIG. 24. In addition, “Σⁿ⁻¹ⱼ₌ᵢ₊₁(d_{j,j+1}+d_{j+1,j})” corresponds to RTT from NFᵢ₊₁ to the offload engine 31.

As can be seen from FIG. 23, the RTT from NFᵢ₊₁ to the offload engine 31 is calculated by Tₙ−Tᵢ₊₁, that is, “RTT from the base station 20 to the offload engine 31”−“RTT from the base station 20 to NFᵢ₊₁”.

The packet processing time in the NF and the offload engine 31 can be calculated from “(R−T₀−Tₙ)×(the ratio of the packet processing time occupied by the NF and the offload engine 31 between the NFᵢ₊₁ and the offload engine 31 among the total packet processing time)”.

Here, the total packet processing time is all NF between the terminal 10 and the offload engine 31 and packet processing time in the offload engine 31.

When the ratio is S, the base station 20 can calculate the guard time in NFᵢ₊₁ as (Tₙ−Tᵢ₊₁)+((R−T₀−Tₙ)×S).

S may be obtained by measurement, or a value determined for each NF in advance may be used.

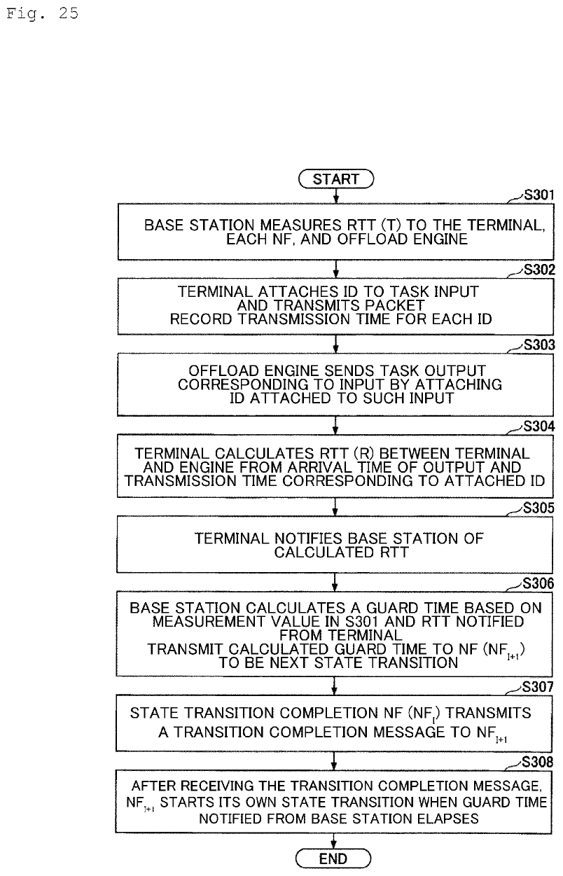

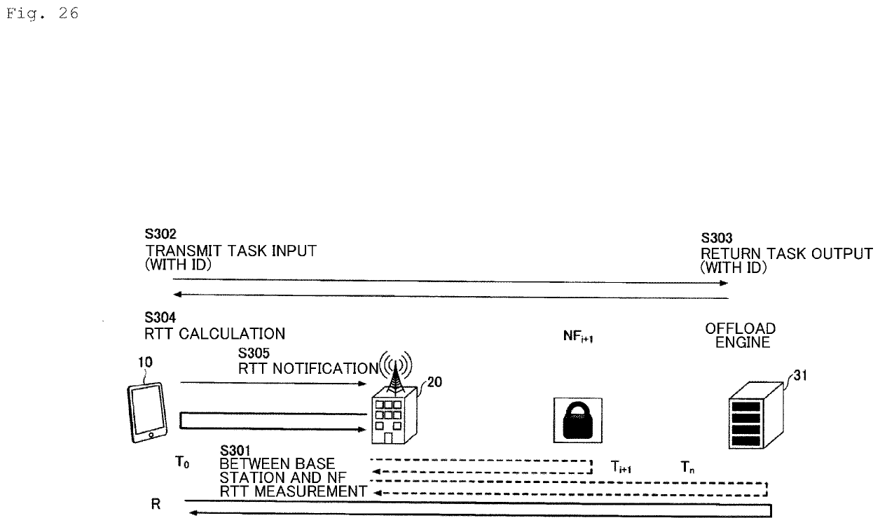

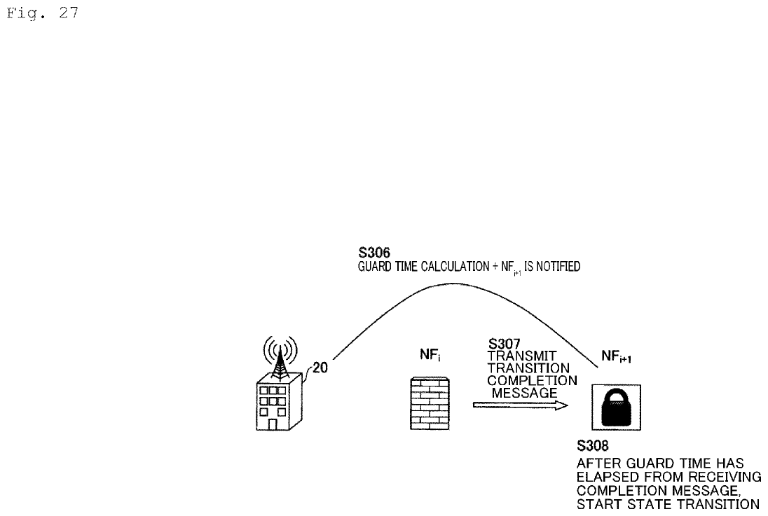

Next, the processing procedure of Example 3 will be described. FIG. 25 is a flowchart of Example 3. FIGS. 26 and 27 show information exchange in the system. The step numbers shown in FIGS. 26 and 27 correspond to the step numbers of the flowchart in FIG. 25. The operation of Example 3 will be described with reference to FIGS. 25, 26, and 27.

S301 to S305 in FIG. 25 correspond to FIG. 26. In S301, the base station 20 measures an RTT (T₀) from the base station 20 to the terminal 10, an RTT (Tᵢ₊₁ or the like) from the base station 20 to each NF, and an RTT (Tₙ) from the base station 20 to the offload engine 31.

In S302, the terminal 10 attaches an ID to the task input and transmits a packet of the task input. This ID is an ID for identifying each task. At this time, the terminal 10 records the transmission time for each ID and sends the task input (packet). In S303, the offload engine 31 returns task output corresponding to task input by attaching an ID attached to the input.

In S304, when receiving the task output returned from the offload engine 31, the terminal 10 calculates RTT (R) between the terminal 10 and the offload engine 31 from the arrival time of the task output and the transmission time corresponding to the attachment ID, according to “the arrival time−transmission time”. In S305, the terminal 10 notifies the base station 20 of the calculated RTT.

S306 to S308 in FIG. 25 correspond to FIG. 27. In S306, the base station 20 calculates a guard time by the above-described method based on the measurement value in S301 and the RTT notified from the terminal 10, and transmits the calculated guard time to the NF (NFᵢ₊₁ in the example of FIG. 27) to be next state transition target.

In S307, the NF (NFᵢ) that has completed the state transition transmits a transition completion message (queuing packet transmission completion notification) to NFᵢ₊₁. In S308, after receiving the transition completion message, the NFᵢ₊₁ starts its own state transition when the guard time notified from the base station 20 elapses. The transition instructions for NFᵢ₊₁ are notified to NFᵢ₊₁ by the state transition supervisor device 100.

### Example 4

Next, Example 4 will be described. In Example 4, functions added to the functions described in Examples 1 to 3 will be described. However, Example 4 may be performed without the premise of Examples 1 to 3.

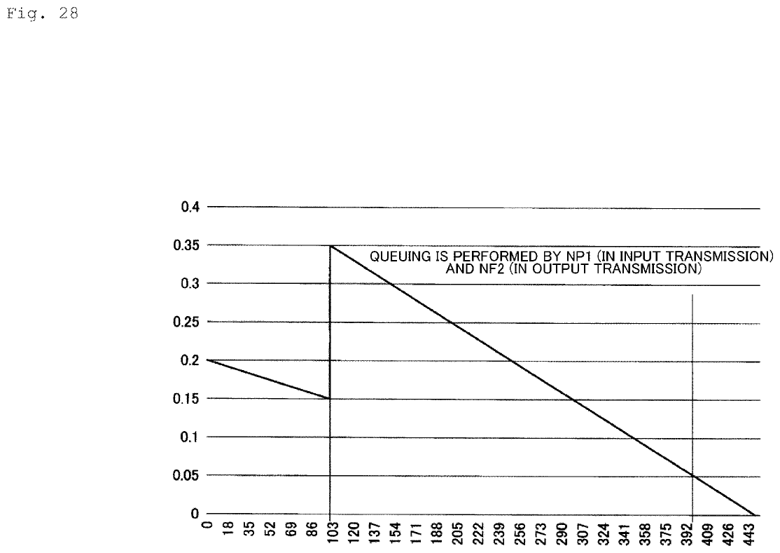

As described with reference to FIG. 7, it is assumed that, for state transition, queuing occurs at NF1 and is queued again at NF2 via offload. In such a situation, the delay increase amount that each task suffers is shown in FIG. 28.

In FIG. 28, the vertical axis represents the amount of delay increase that each task suffers, and the horizontal axis represents the number of task input that has arrived since the start of the state transition of the NF1. The first task input arrives immediately after the start of the NF1 state transition, and the NF1 state transition time=0.2 seconds.

In the following description, for convenience, the horizontal axis is used to express the threshold excess time on the diagram.

In FIG. 28, attention is paid to task input which arrives at NF1 at the 100th time after NF1 starts state transition. FIG. 28 shows a situation where the state transition of the NF2 is started when the task output corresponding to the task input arrives at the NF2. That is, FIG. 28 shows that the total of the time when the task input is queued in the NF1 and the time when the task output outputted after the task input is processed in the offload engine 31 is queued in the NF2 is 0.35 seconds.

When the delay increase as described above occurs in the interactive service and the response deteriorates, the user's experience quality (QoE) deteriorates.

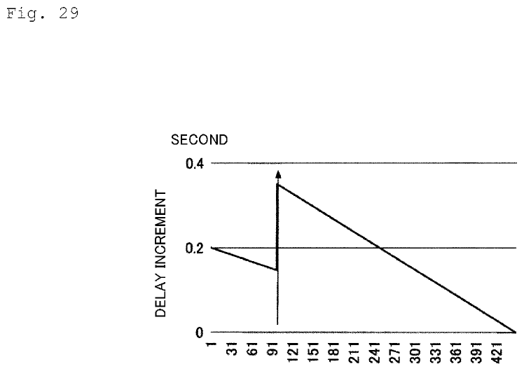

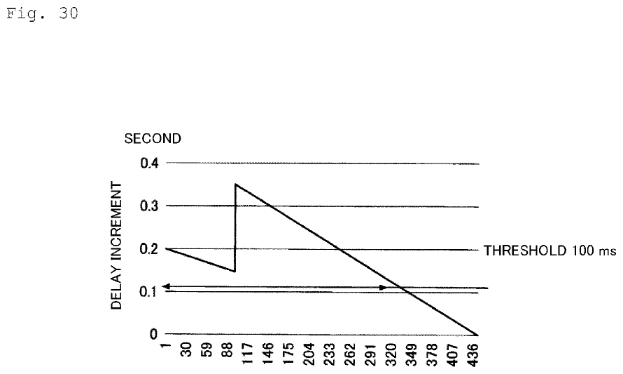

There are two patterns of symptoms that may occur as deterioration in the quality of the user's experience quality. First, as shown in FIG. 29, the image is disturbed when the delay is large. Second, as shown in FIG. 30, when the delay exceeds the delay threshold value is long, the operation becomes heavy and the VR sickness occurs. The threshold value 100 ms illustrated in FIG. 30 is an example.

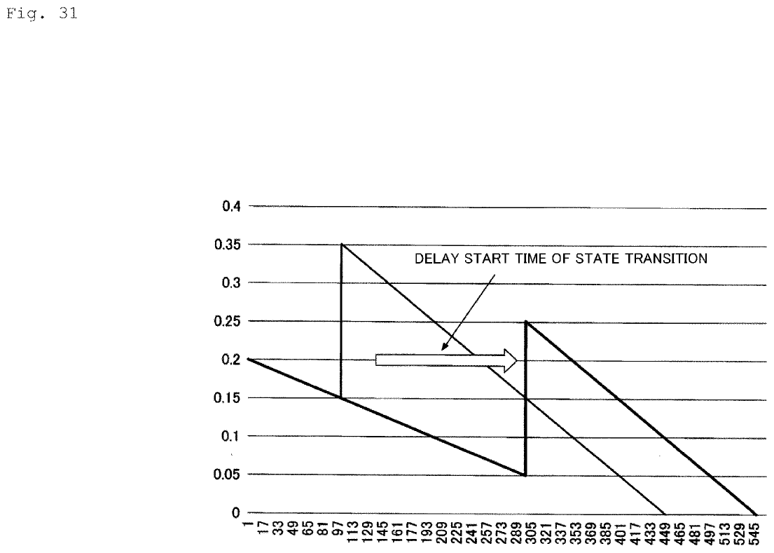

As described in Examples 1 to 3, in this embodiment, the state start time is delayed as shown in FIG. 31. That is, a guard time for the state transition of the NF2 is provided, and the state transition of the next NF is started after the guard time elapses from the completion of the state transition of the previous NF (the completion of the transmission of the queuing packet).

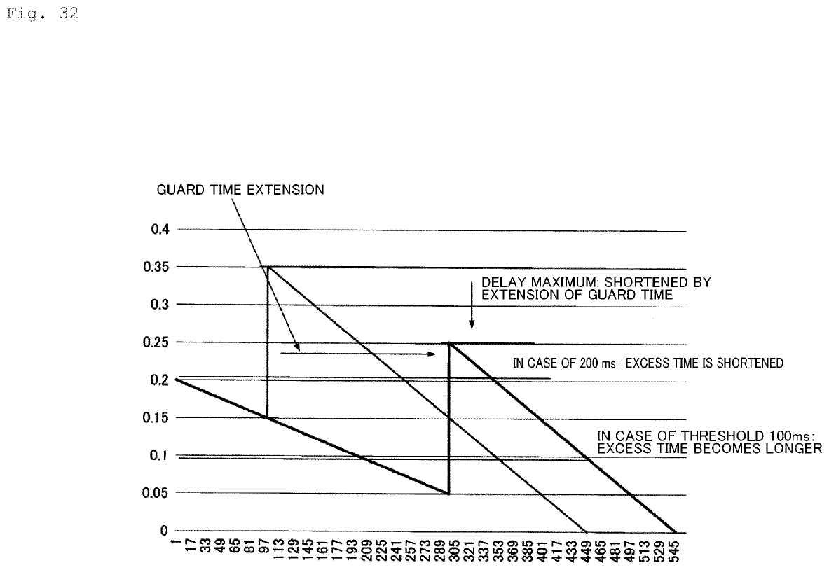

When the guard time is changed, the maximum value of the delay increase amount and the time exceeding the threshold delay amount are changed. More specifically, as shown in FIG. 32, when the guard time is extended, the maximum delay amount becomes shorter. On the other hand, with respect to the threshold excess time, the influence of guard time extension may vary depending on the threshold. For example, in the guard time extension shown in FIG. 32, when the threshold is 200 ms, the threshold excess time becomes short, but when the threshold is 100 ms, the threshold excess time becomes longer.

As described above, the magnitude of the delay (the maximum value of the delay increases amount) and the threshold excess time of the delay influence QoE, respectively. In the Example 4, therefore, the guard time for optimizing QoE is calculated by using a QoE determination function (objective function) using the maximum value of the delay increases amount and the threshold excess time of the delay increase amount as arguments.

The calculation of the guard time at which the QoE is optimal may be calculated by any of the state transition supervisor device 100, the base station 100, and the NF (packet processing device) which have performed the guard time calculation in Examples 1 to 3. Other devices may be used.

For example, as in the example illustrated in FIG. 19, the state transition supervisor device 100 calculates a guard time for which QoE is optimal for NFᵢ₊₁, and instructs the NFᵢ₊₁ to start state transition after the guard time elapses after the state transition completion notification (queuing packet transmission completion notification) is received from NFᵢ.

Further, for example, as in the example illustrated in FIG. 22, the NFᵢ₊₁ calculates a guard time at which QoE is optimal for the NFᵢ₊₁, and starts state transition after the guard time elapses after receiving a state transition completion notification (queuing packet transmission completion notification) from the NFᵢ.

Further, for example, as in the example illustrated in FIG. 27, the base station 20 calculates a guard time for the NFᵢ₊₁ at which QoE is optimal and notifies the NFᵢ₊₁ of the guard time, and the NFᵢ₊₁ starts state transition after the guard time elapses after receiving the state transition completion notification (queuing packet transmission completion notification) from the NFᵢ.

The difference between the guard time described in Examples 1 to 3 and the guard time in Example 4 will be described.

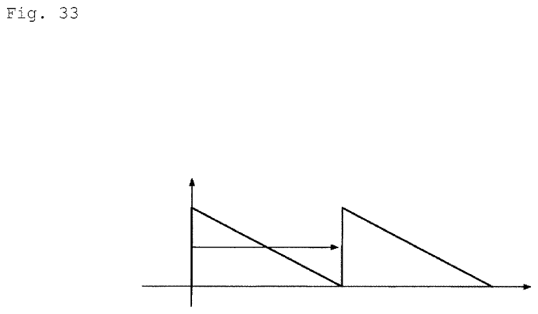

In Examples 1 to 3, the guard time is calculated so that the input and output for the same off-loading task are not queued at a plurality of locations. Therefore, the graph of the delay increase amount and the task number in the case where the guard time is applied is in the form of FIG. 33.

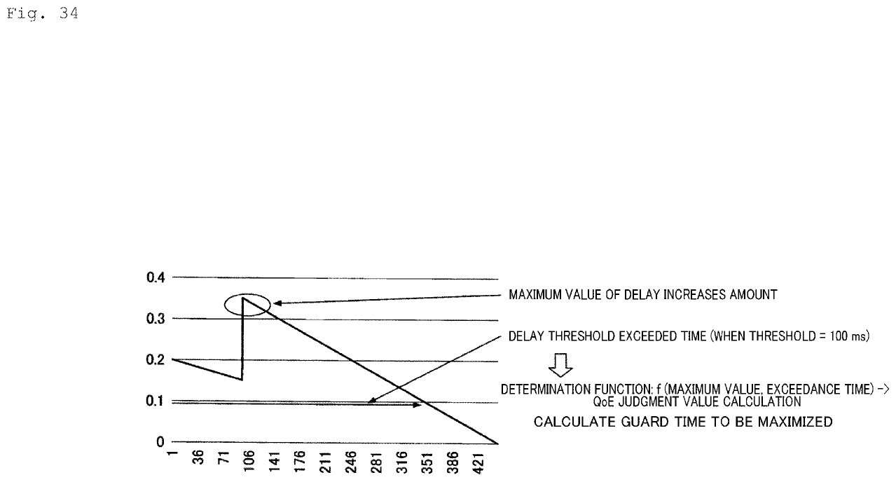

On the other hand, in Example 4, as shown in FIG. 34, on the basis of the QoE determination function having arguments of the maximum value of the delay increases amount resulting from provision of the guard time and the delay threshold excess time, the guard time that optimizes the value of the QoE determination function is calculated.

For the QoE determination function f (the maximum value of the delay increases amount and the delay threshold excess time) in Example 4, for example, QoE corresponding to (the maximum value of the delay increases amount and the delay threshold excess time) may be obtained by an experiment using the maximum value of the maximum value of the delay increases amount and the delay threshold excess time corresponding to various guard times, and an optimal function that is applicable to the experimental value may be used.

As for the guard time corresponding to the maximum value of the delay increases amount and the delay threshold excess time determined by the QoE determination function, the guard time corresponding to the above (the maximum value of the delay increases amount, and the delay threshold excess time) may be used.

For example, various guard times and the corresponding maximum value of the delay increases amount and data of delay threshold excess time for each guard time are stored in advance in a device (state transition supervisor device 100/base station 20/NF) that calculates guard times, and the device determines the guard time corresponding to the maximum value of the delay increases amount and delay threshold excess time determined by the QoE determination function.

An example of a specific calculation formula will be described below for the delay threshold excess time (delay threshold excess occurrence time), the maximum value of the delay increases amount, and the QoE determination. By executing a procedure described later, the state transition management unit 111, the guard time calculation processing unit 211, or the guard time calculation unit 24 calculates the guard time G. As described in the above-described guard time derivation method, the guard time G corresponds to the state transition start time of NFᵢ₊₁ (corresponding to NF2 in the following description) in a case where there is no guard time. In the following explanations, we refer as appropriate to the figure showing the amount of delay increase for each packet (task input) (vertical axis) and the number of packets (task inputs) that have arrived since the start of the NF1 state transition (horizontal axis) in the same situation as in FIG. 28 and others.

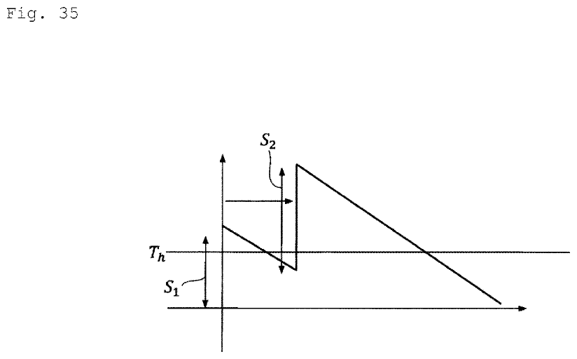

First, symbols used in the following description will be described. As shown in FIG. 35, Tₕ represents a delay threshold, and S₁ and S₂ represent state transition times of NF1 and NF2, respectively. I indicates a packet (task input) arrival interval, and p₁ indicates a packet processing time of the NF1. The packet processing time p₁ of the NF1 may be calculated using the packet processing time of other NF (NF2 or offload engine). The packet processing time affecting the calculation is the largest packet processing time among the NF and the offload engine.

<Calculation Method of Delay Threshold Excess Time>

For the delay threshold excess time, the following equation is used in accordance with the distribution of delay for each corresponding packet.

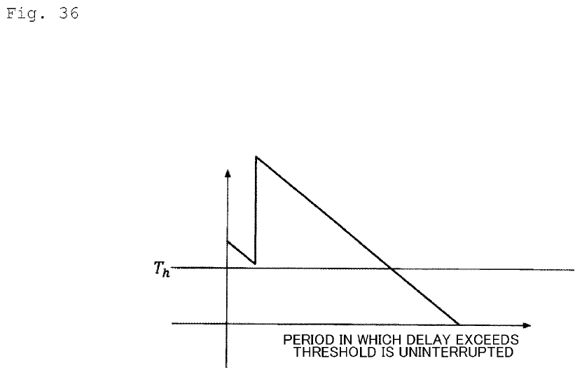

First, as shown in FIG. 36, when a period in which the delay exceeds a threshold is not interrupted (case 1), that is,
when G<((S₁−Tₕ)/(I−p₁))×I,

delay threshold excess time=S₁+S₂+(p₁/I)×G−Tₕ Formula 1

is obtained.

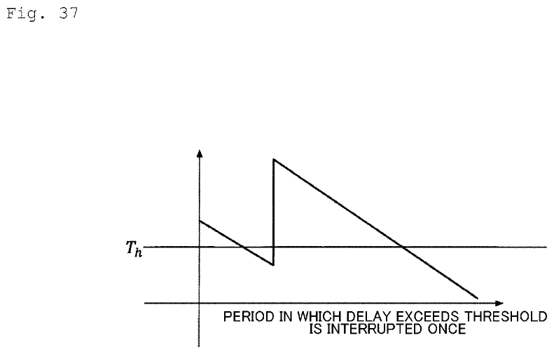

As shown in FIG. 37, when a period in which the delay exceeds a threshold is interrupted once (case 2), that is,
when ((S₁−Tₕ)/(I−p₁))×I<G<((S₁+S₂−Tₕ)/(I−p₁))×I,

delay threshold excess time=((2I−p₁)/(I−p₁))×(S₁−Tₕ)+S₂−(1−(p₁/I))×G Formula 2

is obtained.

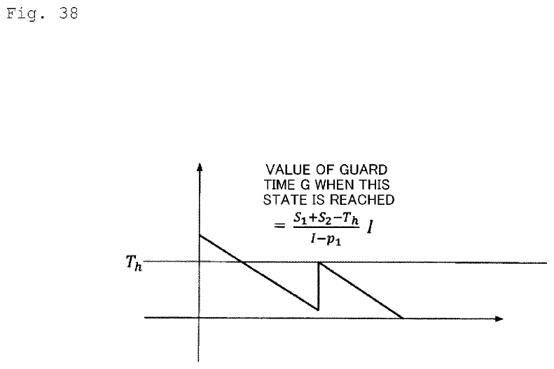

In the case of G=((S₁+S₂−Tₕ)/(I−p₁))×I, the state shown in FIG. 38 is obtained.

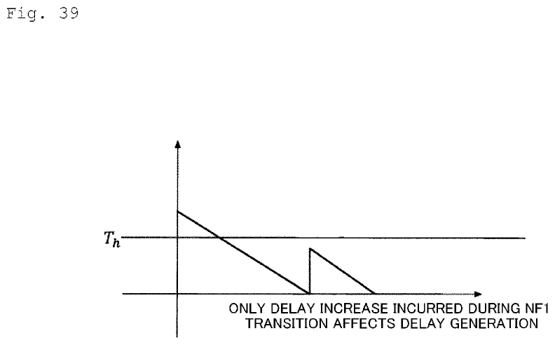

As shown in FIG. 39, in the case other than the cases 1 and 2 (case 3), that is, in other words,
when G>((S₁+S₂−Tₕ)/(I−p₁))×I,
   in other words, when delay increase caused at the time of transition of the NF1 affects delay generation,

delay threshold excess time=((S₁−Tₕ)/(I−p₁))×I Formula 3

is obtained.

The conditional equations of G corresponding to the cases 1, 2 and 3 are called conditional equations 1, 2 and 3, respectively.

<Calculation Formula of Maximum Value of the Delay Increases Amount>

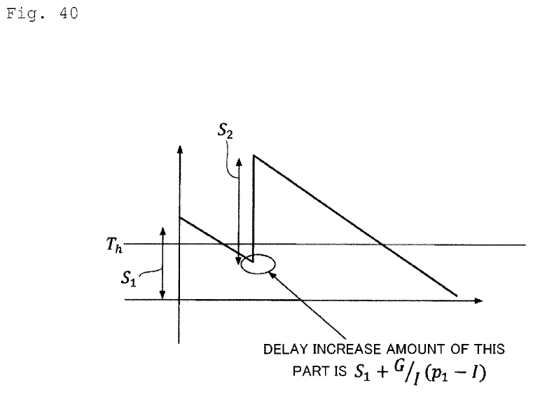

As shown in FIG. 40,

maximum value of the delay increases amount=S₁+S₂+(G/I)×(p₁−I) Formula 4

is obtained.

<Example of QoE Determination Equation>

As the QoE determination equation, the following formula can be used. α is a parameter, and an appropriate value may be determined by experiments or the like.

QoE determination equation=maximum value of the delay increases amount+α×delay threshold excess time Formula 5

An example of a procedure for calculating G using Formula 5 is as follows.

S401) each of expressions 1-3 of the delay threshold excess time and an expression 4 of the maximum value of the delay increases amount are applied to the determination equation 5, and G taking the minimum value is obtained. In other words, for each of equations 1 and 4, equation 2 and equation 4, and equation 3 and equation 4, G is obtained in which equation 5 takes the minimum value.

S402) whether or not the value of G, which is obtained for each condition (case) related to G and in which the determination equation 5 becomes the minimum, matches the conditional equation is checked. For example, when G1 is obtained by a determination equation 5 using Formulas 1 and 4, G2 is obtained by Formulas 2 and 4, and G3 is obtained by Formulas 3 and 4, whether G1 satisfies conditional equation 1 is checked, whether G2 satisfies conditional equation 2 or not is checked, and whether G3 satisfies conditional equation 3 or not is checked.

S403) the G with the minimum determination equation 5 is selected as a solution among G matching the conditional equation. For example, when G1 and G2 satisfy the conditional equation, G2 is selected when G2 is smaller than G1 in the value of determination equation 5.

### Effect of Embodiment

According to the technique described in the present embodiment, it is possible to improve the quality of the user's experience quality when rearranging flows flowing through the network function.

### Summary of Embodiment

At least the guard time calculation device, the guard time calculation method, and the program according to the following items are described in the present specification.

(Item 1)

A guard time calculation device, which is used in a network system including a terminal, a plurality of network functions, and an offload device, the guard time calculation device, comprising:
in a case where a state transition of a second network function is performed next to a state transition of a first network function, after outputting a packet from the second network function, a calculation means that is provided to calculate time it takes that the packet arrives at the offload device via 0 or more network functions, and is processed in the offload device, and the packet after processing arrives at the second network function via zero or more network functions, wherein
after the state transition of the first network function is completed and a queued packet is transmitted, the state transition of the second network function is started after a lapse of a guard time on the basis of the time.

(Item 2)

The guard time calculation device according to item 1, wherein the guard time calculation device calculates the time on the basis of a plurality of network functions configuring the network system and data measured by the offload device.

(Item 3)

The guard time calculation device according to item 1, wherein the guard time calculation device is one network function among a plurality of network functions configuring the network system, describes an ID of the network function and a transmission time in a header of a packet, transmits the packet, and calculates the time by receiving a processed packet that has been processed the packet in the offload device.

(Item 4)

The guard time calculation device according to item 1, wherein the guard time calculation device is a base station connected to the terminal, and calculates the time using an RTT to the terminal, an RTT to the second network function, an RTT to the offload device, and an RTT from the terminal to the offload device.

(Item 5)

A guard time calculation device, which is used in a network system including a terminal, a plurality of network functions, and an offload device, the guard time calculation device, comprising:
in a case where a state transition of a second network function is performed next to a state transition of a first network function, a calculation means for calculating a guard time at which a QoE is optimal, based on a QoE determination function that takes as arguments a maximum value of a delay increases amount of a packet caused by providing the guard time before the state transition of the second network function and a delay threshold excess time, wherein
after the state transition of the first network function is completed and a queued packet is transmitted, the state transition of the second network function is started after a lapse of a guard time.

(Item 6)

A guard time calculation method, which is performed by a guard time calculation device that is used in a network system including a terminal, a plurality of network functions, and an offload device, the guard time calculation device, comprising:
in a case where a state transition of a second network function is performed next to a state transition of a first network function, after outputting a packet from the second network function, a calculation step that is provided to calculate time it takes that the packet arrives at the offload device via 0 or more network functions, and is processed in the offload device, and the packet after processing arrives at the second network function via zero or more network functions, wherein
after the state transition of the first network function is completed and a queued packet is transmitted, the state transition of the second network function is started after a lapse of a guard time on the basis of the time.

(Item 7)

A program for causing a computer to function as a calculation means in the guard time calculation device according to any one of items 1 to 5.

The embodiment has been described above, but the present invention is not limited to the specific embodiment. Various modifications and changes can be made within the scope of the gist of the present invention described in the claims.

### REFERENCE SIGNS LIST

10 Mobile terminal
20 Base station
21 Input/output interface
22 Storage unit
23 Data acquisition unit
24 Guard time calculation unit
30 Edge cloud device
31 Offload engine
100 State transition supervisor device
110 Processing function unit
111 State transition management unit
120 Storage unit
130 Input/output interface
200, 201 to 203, 221 to 223 Packet processing device
210 Processing transfer function unit
211 Guard time calculation processing unit
212 State transition processing unit
213 Packet processing transfer unit
220 Storage unit
230 input/output interface
1000 Drive device
1001 Recording medium
1002 Auxiliary storage device
1003 Memory device
1004 CPU
1005 Interface device
1006 Display device
1007 Input device
1008 Output device

1. A guard time calculation device, which is used in a network system including a terminal, a plurality of network functions, and an offload device, the guard time calculation device comprising:
a memory; and
a processor configured to
in a case where a state transition of a second network function is performed next to a state transition of a first network function, after outputting a packet from the second network function, calculate time it takes that the packet arrives at the offload device via zero or more network functions, and is processed in the offload device, and the packet after processing arrives at the second network function via the zero or more network functions,
wherein after the state transition of the first network function is completed and a queued packet is transmitted, the state transition of the second network function is started after a lapse of a guard time on the basis of the time.

2. The guard time calculation device according to claim 1, wherein the guard time calculation device calculates the time on the basis of a plurality of network functions configuring the network system and data measured by the offload device.

3. The guard time calculation device according to claim 1, wherein the guard time calculation device is one network function among a plurality of network functions configuring the network system, describes an ID of the network function and a transmission time in a header of a packet, transmits the packet, and calculates the time by receiving a processed packet that has been processed the packet in the offload device.

4. The guard time calculation device according to claim 1, wherein the guard time calculation device is a base station connected to the terminal, and calculates the time using an RTT to the terminal, an RTT to the second network function, an RTT to the offload device, and an RTT from the terminal to the offload device.

5. A guard time calculation device, which is used in a network system including a terminal, a plurality of network functions, and an offload device, the guard time calculation device comprising:
a memory; and
a processor configured to
in a case where a state transition of a second network function is performed next to a state transition of a first network function, calculate a guard time at which a QoE is optimal, based on a QoE determination function that takes as arguments a maximum value of a delay increases amount of a packet caused by providing the guard time before the state transition of the second network function and a delay threshold excess time,
wherein after the state transition of the first network function is completed and a queued packet is transmitted, the state transition of the second network function is started after a lapse of a guard time.

6. A guard time calculation method, which is performed by a guard time calculation device that includes a memory and a processor, and is used in a network system including a terminal, a plurality of network functions, and an offload device, the guard time calculation method comprising:
in a case where a state transition of a second network function is performed next to a state transition of a first network function, after outputting a packet from the second network function, calculating time it takes that the packet arrives at the offload device via zero or more network functions, and is processed in the offload device, and the packet after processing arrives at the second network function via the zero or more network functions,
wherein after the state transition of the first network function is completed and a queued packet is transmitted, the state transition of the second network function is started after a lapse of a guard time on the basis of the time.

7. A non-transitory computer-readable recording medium having computer-readable instructions stored thereon, which, when executed, cause a computer including a memory and processor to function as the guard time calculation device according to claim 1.
